(19) United States
(12) Patent Application Publication
(10) Pub. No.: US 2012/0182149 A1
(43) Pub. Date: Jul. 19, 2012

(54) SENSOR DEVICE OF EYELID BLINKS USEFUL IN PREVENTION AND EARLY WARNING STATES OF DROWSINESS

(76) Inventors: José Antonio Moreno Valenzuela, Santiago (CL); Juan Carlos Faundez Lorca, Santiago (CL)

(21) Appl. No.: 13/498,653

(22) PCT Filed: Sep. 23, 2010
(86) PCT No.: PCT/CL10/00040

§ 371 Date: Mar. 28, 2012

(30) Foreign Application Priority Data
Sep. 28, 2009 (CL) 1908-2009

(51) Int. Cl. G08B 21/06

(52) U.S. Cl. 340/575

(57) ABSTRACT

The present invention comprises a transmitter and an infrared sensor to control the eyelid blinks of the user, useful in the prevention and warning of drowsiness, which includes the generation of an alarm, which preferably is a sound alarm indicated for individuals who make repetitive activities and/or routines, such as drivers of passenger transport and cargo, vehicles operators, industrial machinery security and oversight activities or another that requires the permanent attention of the individual.

### SPECIFICATION

The device of the present invention comprises a transmitter and an infrared sensor to control the eyelid blinks of the user, useful in the prevention and warning of drowsiness, which includes the generation of an alarm, which preferably is a sound alarm indicated for individuals who make repetitive activities and/or routines, such as drivers of passenger transport and cargo, vehicle operators, industrial machinery, security and oversight activities or any other that requires the permanent attention of the individual.

### BACKGROUND OF THE INVENTION

In the state of the art, there are varied drowsiness detection and warning systems for drivers or workers who perform repetitive actions and requiring concentration. Among them, are patents U.S. Pat. No. 4,397,531, U.S. Pat. No. 4,625,329, U.S. Pat. No. 4,725,824, U.S. Pat. No. 5,402,109, U.S. Pat. No. 5,909,179. To name some, the U.S. Pat. No. 5,402,109 comprises an adaptable drowsiness alert device structures type glasses which have on one side a signal transmitter and in the opposite end a signal detector. The device has a complex electronics to analyze the amplitude and frequency of the signals, and determines if the alert is activated.

### BRIEF DESCRIPTION OF THE INVENTION

The device of the present invention comprises at least one signal emitter and a sensor that operates with the refraction of light in the skin of the eyelid. The sensor is mounted on a structure type frame of glasses, these glasses can possess corrective glasses (optical glasses), or have no crystals.

The device of the present invention can be used by any user, it has adjustment means that give mobility to the device on the frame which is mounted, the mobility of the device in two degrees of freedom (horizontal and vertical axes) in order to adapt the sensor to the facial anatomy of the user.

The device of the invention is activated with a signal that is refracted on the surface of the user eyelid. Said activation generates an alarm when the eyelid of the user is closed for one time greater than during a normal blinking; where the “normal blinking” refers to the duration of the flashing on alertness.

The operation of the device includes the following stages: the emission of a signal for the eye of the user, when the eye is open the signal is reflected, refracted and/or absorbed, and when the user closes the eye, the eyelid is interposed between the eye and the signal, and the signal is refracted. The sensor captures the signal, and according to the duration of the flashing, generates an alarm.

### DESCRIPTION OF THE FIGURES

FIG. 1 shows a schematic view of the device of the invention proposed in one of its embodiments, showing the device mounted on a frame, with the transmitter/receiver module (3) and the adjustment means (1 and 2) , where (2) corresponds to a led that helps adjust the device to the anatomy of the user.

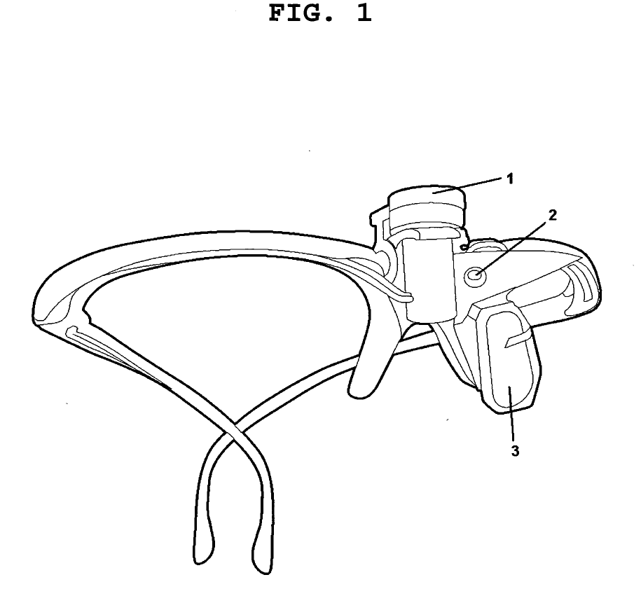

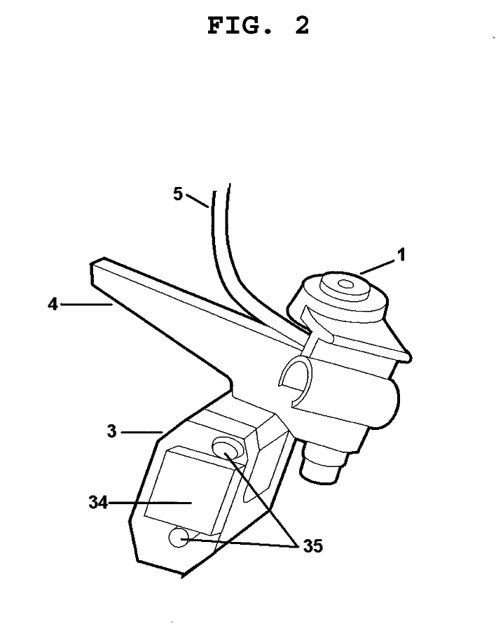

In FIG. 2 you can see in more detail the components of the device of the present invention, in one of the proposed embodiments, where 34 corresponds to the receiving sensor of the device, 35 corresponds to the transmitter of signals, 5 shows the communication cable that sends data from the signal you want to activate. In addition you can see the vertical adjustment means (1) and horizontal (5) to adapt the device to the anatomy of the user.

### DETAILED DESCRIPTION OF THE INVENTION

The device of the present invention comprises at least one transmitter (35) and a infrared receiver (34), located in contiguous, in a mini electronic board (3), which preferably is mounted on a structure type frame of glasses or lenses. The transmitters and the infrared receiver are located toward the eye of the user. The sensor is activated when it detects the broadcast signal after this is reflected or refracted on any surface, as in this case, the eyelid of the user.

The device of the invention is mounted or disposed on the frame of the structure type frame lens, placing the device preferably in the position of the nose of the user. The device of the present invention allows to adapt to the anatomy of the user; for this the device comprises means conferred mobility in two degrees of freedom, preferably the vertical axis and horizontal axis. Such means of adjustment includes a screw that allows to regulate the relative height of the device (1) and a tab or lever that allows movement on its axis (4). In addition, the device provides a visual indicator of the eye that serves as a reference, such as a mini-led (2), which is operated during the process of adjustment of the device to the user to align the transmitter and sensor in an optimal direction for reflection, delivering greater convenience to the user, and avoiding false alarms and eventually, possible damage to the user during use of the device.

Let us remember that signals emitted or transmitted to a surface, are subject to three phenomena:
Absorption of the signal
Reflection of the signal, depending on the angle, and
Refraction of the signal.

In the case of the open eye signal transmitted by the issuer is mostly reflected or absorbed, so that the sensor is inactive. In counterpart, on the eyelid of the user signal is refracted, so part of the signal is detected by the sensor of the device of this invention.

The device of the invention provides the emission of at least two signals from different heights relative to the eye of the user, in order to make compensation for the opening of the eye to different conditions of light and shadow in the environment in which the device is used. When there is more light available on the medium, for example, sun light, the eye opening is considered less than when there is less light, as it is the case during the afternoon hours.

The device of the present invention includes a circuit gain control connected to the sensor, which also allows to adjust the sensitivity of measurement of this sensor depending on the anatomy of the user, i.e., can be also adjusted according to the distance between the eye of the user and the transmissor sensor of signals, increasing or decreasing the gain of the signal. The detected signal is transmitted to a computer, where the data is analyzed and the alarm signal is generated. Each flashing signal is analyzed by a micro controller, which has a counter that determines the duration of the eyelid blinks; in the process of adaptation of the device to the user, is stored in memory the duration of the normal blinking of the user, for later comparisons; the duration of each flicker is compared to the duration of the normal blinking, and if there is an increase generates a log of such an increase, if the situation is repeated the micro controller activates the alert signal.

1. A device for the detection and alertness state of drowsiness CHARACTERISED in that it comprises a structure type frame of glasses or lenses, means of adjustment of the device to the anatomy of the user, two signal emitters o transmissors and a sensor, which operates with the refraction of light in the skin of the eyelid and a micro controller; that generates an alarm signal, preferably an alarm sound, useful for individuals engaged in repetitive activities and/or routines, such as drivers of transport of people and cargo, vehicles operators, industrial machinery, security and oversight activities or other activity that requires the permanent attention of the individual.

2. The detection and alertness state of drowsiness device according to claim 1, CHARACTERIZED in that such means of adjustment includes a screw (1) that allows to regulate the relative height of the device.

3. The detection and alertness states of drowsiness device according to claim 1, CHARACTERIZED in that such means of adjustment includes a tab or lever (4) that allow the movement on its axis.

4. The detection and alertness states of drowsiness device according to claim 1, CHARACTERIZED in that such means of adjustment includes a visual indicator of the eye (2), which serves as a reference for aligning the emitter or transmissor and sensor in an optimal direction of reflection.

5. The detection and alertness states of drowsiness device according to claim 1, CHARACTERIZED in that such visual indicator of the eye (2) preferably is a mini-led.

6. The detection and alertness states of drowsiness device according to claim 3, CHARACTERIZED in that such signal emitter is preferably an infrared emitter.

7. The detection and alertness states of drowsiness device according to claim 1, CHARACTERIZED in that such sensor is specific to detect the signal emitted or transmitted by the transmissor.

8. The detection and alertness states of drowsiness device according to claim 1, CHARACTERIZED in that the micro controller stores the length of the normal blinking of the alertness user, and then compares the duration of each flicker with the reference, determining the activation of the alarm.

9. The detection and alertness states of drowsiness device according to claim 1, CHARACTERIZED in that such device preferably comprises two signals emitters or transmissors in different heights relating to the eye of the user, in way of compensating for the opening of the eye to different light conditions environments.
